(19) United States
(12) Patent Application Publication
(10) Pub. No.: US 2020/0079388 A1
(43) Pub. Date: Mar. 12, 2020

(54) INTELLIGENT VEHICULAR SYSTEM FOR REDUCING ROADWAY DEGRADATION

(71) Applicant: Dish Network L.L.C., Englewood, CO (US)

(72) Inventor: Christopher Michael Kenyon, Cheyenne, WY (US)

(21) Appl. No.: 16/126,266

(22) Filed: Sep. 10, 2018

(51) Int. Cl. B60W 40/10; B60W 40/06

(52) U.S. Cl. CPC B60W 40/10; B60W 2550/147; B60W 40/06

(57) ABSTRACT

Various embodiments of systems, apparatus, and/or methods are described in connection with intelligent vehicular computers. In some embodiments, an intelligent vehicle computer in a first vehicle can be configured to reduce roadway degradation by causing a driving path of the first vehicle to be staggered with respect to the driving path of a second vehicle by applying different offset displacements to the original driving paths of the first vehicle and the second vehicle. The offset displacements applied by each vehicle can be calculated in real-time based on environmental variables and vehicular data collected from sensors associated with the first vehicle and the second vehicle. Application of different offset displacements by different vehicles allows greater usage of the roadway, thereby reducing roadway degradation from repetitive driving on the same areas of the roadway.

### TECHNICAL FIELD

The present disclosure is related to the field of intelligent vehicular systems. More particularly, the present disclosure is directed at a vehicular system that reduces roadway degradation causing a driving path of a first vehicle to be staggered with respect to the driving path of a second vehicle by applying different offset displacements to the original driving paths of the first vehicle and the second vehicle. The offset displacements applied by each vehicle can be calculated in real-time based on environmental variables and vehicular data collected from sensors associated with the first vehicle and the second vehicle. Application of different offset displacements by different vehicles allows greater usage of the roadway, thereby reducing roadway degradation from repetitive driving on the same areas of the roadway.

### BACKGROUND

The inefficiencies of the road transportation system have a significant impact on our lives. In some instances, efforts at cutting costs and optimizing resources by companies and individuals can result in freight trucks carrying heavier and heavier loads. The wear and tear caused by heavy trucks is worsening maintenance conditions. In many places, weighty 18-wheelers are regularly traveling at high speeds on roads that were never meant to carry them. To make matters worse, in many areas, state and federal jurisdictional authorities are sometimes unable to repair the road transportation system for several reasons such as lack of knowledge of worn-out road locations, reduced funding, unfavorable weather conditions, official policy, or otherwise any other reason. Thus, the conditions of the road transportation system either stays the same or continues to deteriorate. Poor roads can cost humans to be subjected to exorbitant car repair fees, unrealized safety improvements might result in hardship, injury and even death. Some high-end cars are equipped with sensors capable of spotting a vehicle in a driver's blind spot, or warning that the car is drifting out of a lane. However, these technologies generally do not address the issues arising due to a poor road transportation system. Thus, there is an increased need for systems and methods that can address the challenges of a poor road transportation system.

### BRIEF DESCRIPTION OF THE DRAWINGS

FIGS. 1A and 1B illustrate an example scenario of roadway degradation based on conventional driving.

FIGS. 1C and 1D illustrate an example scenario of reduced roadway degradation based on employing the disclosed technology.

FIG. 2 illustrates an example environment of operation of the disclosed technology.

FIG. 3 illustrates an example of a car fitted with multiple sensors.

FIGS. 4A and 4B illustrate various examples of offset displacements applicable to tire placement of vehicles.

FIG. 5 illustrates an example architecture of a vehicular computer according to some embodiments of the disclosed technology.

FIG. 6 illustrates an example architecture of a remote computer communicably coupled to a vehicular computer, according to some embodiments of the disclosed technology.

FIG. 7 illustrates steps of a flowchart associated with calculating an offset displacement applicable to tire placement, according to some embodiments of the disclosed technology.

FIG. 8 illustrates steps of a flowchart associated with a first vehicle modifying its driving path based on offset displacement applied by a second vehicle on the roadway, according to some embodiments of the disclosed technology.

### DETAILED DESCRIPTION

Embodiments of the present application are directed at systems and methods associated with intelligent vehicular computers that reduce roadway degradation and improve the lifetime of roadways. A driving path of a first vehicle is caused to be staggered with respect to the driving path of a second vehicle by applying different offset displacements to the original driving paths of the first vehicle and the second vehicle. The offset displacements applied by each vehicle can be calculated in real-time based on environmental variables and vehicular data collected from sensors associated with the first vehicle and the second vehicle.

In some embodiments, the offset displacement for a vehicle is calculated with respect to at least one tire of the vehicle, and includes a distance and a direction. The offset displacement when applied to the vehicle causes the original path of the vehicle to be dynamically modified. As a result, applying the offset displacement for tire placement results in reduced degradation of the roadway. The offset displacement can be applied regardless of the presence of structural artifacts like potholes, bumps, dips, or ruts on the road. One advantage of the disclosed technology is that different offset displacements by different vehicles on the road causes the vehicle to be staggered with respect to one another, thereby allowing greater usage of the roadway. As a result, the wear and tear of the roadway (from a vehicle travelling on the roadway) gets spread out over a wider portion of the roadway. Further, because the vehicles are staggered with respect to one another, degradation from the conventional “middle of the road” driving is reduced, thereby increasing the lifetime of the roadway.

In some embodiments, staggering of the vehicles can be achieved based on inter-vehicular and intra-vehicular communications. Inter-vehicular communications involve electronic (typically wireless) communications with one or more nearby vehicles traveling on the road. Intra-vehicular communications include environmental parameters and vehicular data that can be collected by sensors coupled to the vehicle. Examples of environmental parameters can include an ambient temperature, an ambient pressure, an ambient humidity, a condition of the roadway, a wind speed, an amount of rainfall, an amount of snow, an amount of ambient light, or other suitable environmental parameter that can be collected by an electronic or mechanical sensor. Examples of vehicular data can include operational data associated with at least one tire (e.g., the tire closest to the structural artifact on the roadway) such as a speed of travel of the tire, an acceleration of the tire, a direction of travel of the tire, a vehicular weight on the tire, and a frictional force of the roadway impacting the tire. In some embodiments, the offset displacement is also based on object data, e.g., one or more objects located on the portion of the roadway where the vehicle is moving. Examples of objects can include a pole, a traffic light, a boundary wall, a shoulder of the roadway, one or more other vehicles in proximity of the vehicle, a pedestrian, an animal, a tower, a tree, a building, a sidewalk, a partition on the roadway, a road barrier, a fence, a construction zone, lane markings, a traffic marking cones or barrel, a road divider, or any other object on the roadway that can be detected by sensors. Disclosed embodiments are applicable to any type of vehicle, including but not limited to self-driving cars. Various embodiments, advantages, and aspects of the disclosed technology will be apparent in the following discussions.

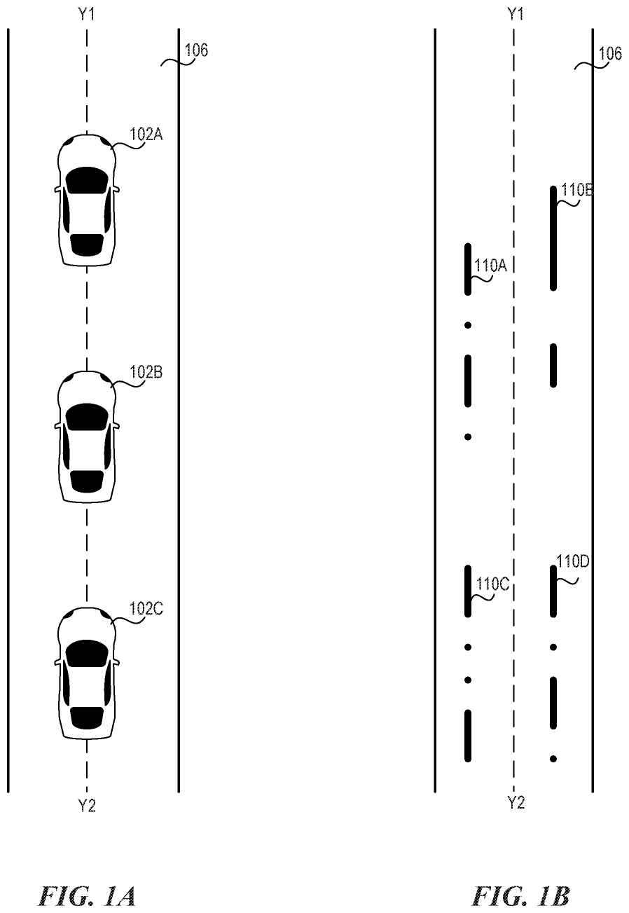

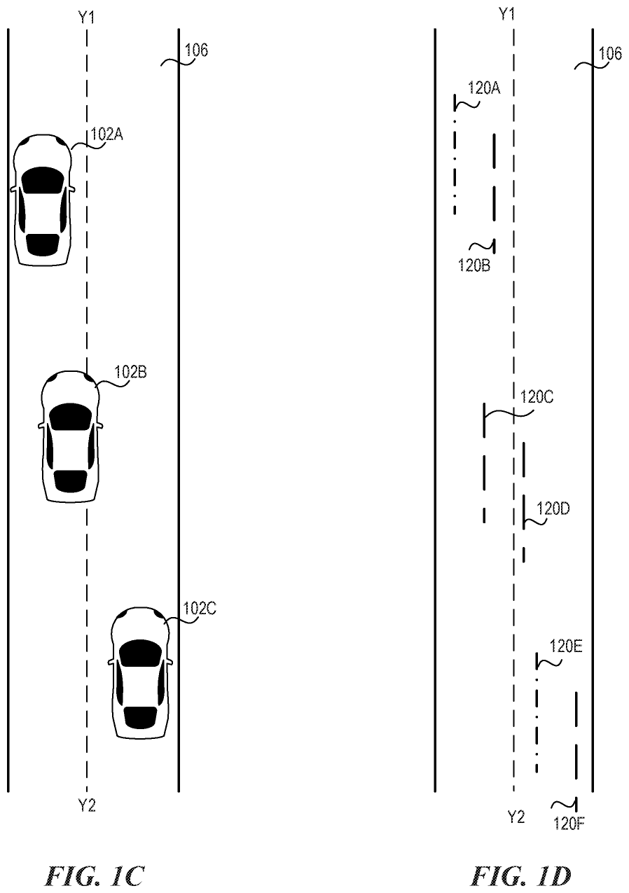

FIGS. 1A and 1B illustrate an example scenario of roadway degradation based on conventional driving. For example, FIG. 1A shows an original path Y1Y2 taken by vehicles 102A, 102B, 102C on roadway 106 based on conventional “middle of the road” driving. In other words, 102A, 102B, 102C are traveling along the same common straight line, e.g., following one another with little or no horizontal deviation with respect to one another. FIG. 1B shows the undesired effect of such driving practice. For example, FIG. 1B shows grooves, ruts, roadway deformities, or generally artifacts 110A, 110B, 110C, 110D formed from repeated “middle of the road” driving. The artifacts may not necessarily be the same. For example, certain sections of the roadway may be affected greater than other sections of the roadway. Further, the shape (e.g., size, shape, width, depth, etc.) of the deformities may be different.

FIGS. 1C and 1D illustrate an example scenario of reduced roadway degradation based on employing the disclosed technology. For example, FIG. 1C shows vehicles 102A, 102B, 102C are travelling staggered or offset with respect to one another. As a result, the deformities on the roadway, shown as 120A, 120B, 1200, 120D, 120E, 120F in FIG. 1D, are less severe because the same section of the roadway is not taken by multiple vehicles, effectively spreading the wear and tear of roadway over a larger portion of the roadway, thereby reducing the degradation of the roadway. The offset displacement applied by a vehicle can be measured with a suitable axis/frame of reference associated with the vehicle (e.g., left tires or right tires) or the roadway. For example, offset displacement can be measured with respect to the axis Y1Y2 in the middle of the roadway.

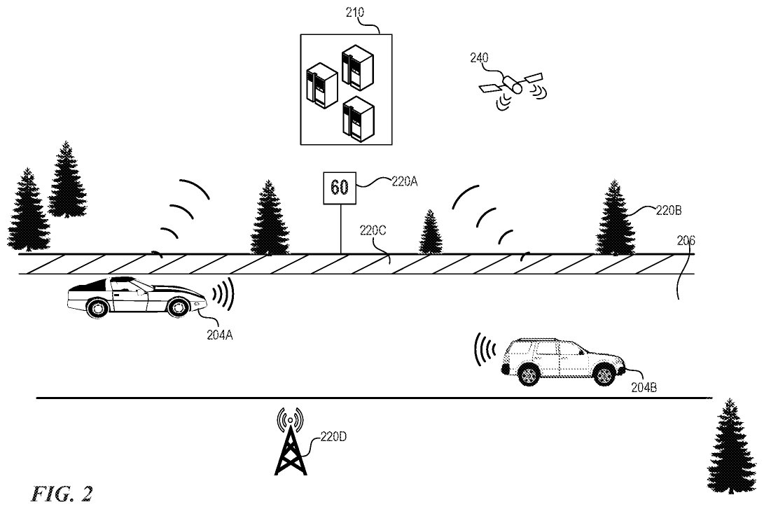

FIG. 2 illustrates an example scenario of operation of the disclosed technology. Cars 204A and 204B are traveling on a portion of roadway 206. However, the direction of travel of cars 204A and 204B are shown staggered with respect to one another, i.e., cars 204A, 204B do not travel along a common straight line.

According to disclosed embodiments, car 204A can modify its path by applying an offset displacement to its tire placement, thereby reducing degradation of roadway 206. Also, car 204B can apply another offset displacement to its tire placement. The offset displacement applied by cars 204A and 204B are different and thus result in cars driving in different portions of roadway 206. Thus, one benefit of the disclosed technology is greater usage of roadway 206 and reducing wear and tear from repetitive driving on a certain section of roadway 206.

Cars 204A and 204B can be equipped with multiple sensors such that allow them to communicate with one another. For example, the offset displacement taken by car 204B can be communicated to car 204A so that car 204A can apply a different offset displacement than the offset displacement applied by car 204B. Further, cars 204A, 204B can also communicate with one or more remote servers 210 and/or satellite 240 via sensors coupled to cars 204A, 204B. Objects 220A, 220B, 220C, 220D are located/positioned on the portion of roadway 206. Object 220A is a speed limit sign. Object 220B is a tree. Object 2200 is a shoulder of the portion of roadway 206. Object 220D is a communication tower. Communications between cars 204A, 204B or between remotes servers 210 and a vehicle (e.g., car 204A) can employ any suitable type of wireless technology, such as Bluetooth, Wifi, WiMax, cellular, single hop communication, multi-hop communication, Dedicated Short Range Communications (DSRC), or a proprietary communication protocol. Cars 204A, 204B can obtain their geographical positions on roadway 206 with the help of GPS information from satellite 240.

In some embodiments, car 204B can communicate information about its offset displacement to server 210 and/or car 204A. Car 204A can also communicate its geographical location, e.g., obtained using data collected from sensors coupled to car 204B. In some embodiments, server 210 can communicate information about the offset displacement of each vehicle to other vehicles on roadway 206. Thus, according to disclosed embodiments, information about structural artifacts on a roadway can be determined by a car or vehicle itself, e.g., using sensors coupled to the car. Although FIG. 2 shows a scenario with two cars 204A, 204B, embodiments of the disclosed technology can be applicable in scenarios with any number or types of cars. Also, offset displacement of a car can be communicated to any number of vehicles on the roadway. In some embodiments, the offset displacement applied by a vehicle is communicated by the vehicle to server 210 which then broadcasts the offset displacement to vehicles occupying a certain portion of the roadway and proximal to the vehicle. Thus, in some embodiments, vehicles on the roadway receive periodic or intermittent updates from server 210 with information about offset displacements taken by other proximal vehicles on the roadway.

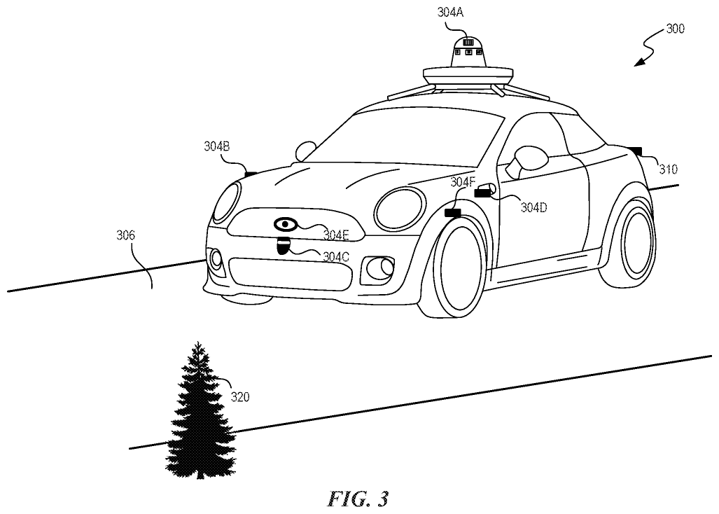

FIG. 3 illustrates an example of a vehicle (e.g., vehicle 300) fitted with multiple sensors traveling on roadway 306. For example, FIG. 3 shows vehicle 300 coupled with sensors 304A, 304B, 304C, 304D, 304E, 304F. Sensors 304A, 304B, 304C, 304D, 304E, 304F can be of the same or different types. There is no limitation on the number or the type of sensor(s) that can be coupled to a vehicle. For example, sensor 304A and 304E can be LIDAR units that spin continuously. Using laser beams emitted from a LIDAR unit, the LIDAR unit can generate a 360-degree image of the surroundings of vehicle 300. The image can be a map of one or more objects (e.g., object 320) within a suitable vicinity of vehicle 300. Sensors 304B, 304D, 304F can be radar units, which can measure distance between vehicle 300 and other objects or vehicles on roadway 306. In some embodiments, one or more camera units can be attached to the top of vehicle 300, e.g., adjacent to sensor 304A. Cameras can also help detect objects or vehicles on roadway 306, or in some scenarios, the edge, end of lane, or a shoulder of roadway 306. In some embodiments, any of sensors 304A, 304B, 3040, 304D, 304E, 304F can be a GPS unit capable of determining a current location of vehicle 300. In some embodiments, cameras can include multiple lenses of differing focal lengths—wide angle, standard and long distance—to view roadway 306. Further, cameras can be forward-facing and/or backward-facing. Also, blind-spot detection and lane-departure warning sub-systems included in the vehicular computer can use any of sensors 304A, 304B, 304C, 304D, 304E, 304F.

Data from one or more sensors are collected and analyzed at vehicular computer 310, For example, a map generated by the LIDAR unit(s), radar unit(s), and/or cameras can be integrated with information received from a GPS unit for vehicle 300 to determine “its bearings in the world in real time.” Radar units transmit radio waves to an object and interpret the reflection back from the object under different weather and light conditions. In some embodiments, any of sensors 304A, 304B, 304C, 304D, 304E, 304F can detect the presence of structural artifacts or roadway deformities on a portion of roadway 306, based on monitoring the portion of roadway 306.

Although FIG. 3 shows vehicular computer 310 located in the rear (e.g., the trunk) of vehicle 300, in some embodiments, vehicular computer 310 can be located anywhere within vehicle 300, Further, vehicular computer 310 can be retrofitted (e.g., as an add-on) into older “legacy” vehicles, or coupled to and/or integrated with a newer vehicle having an existing vehicular computer, That is, one advantage of the present technology is that the architecture of vehicular computer 310 supports any type of vehicle, regardless of the age or the “technological level” of a vehicle.

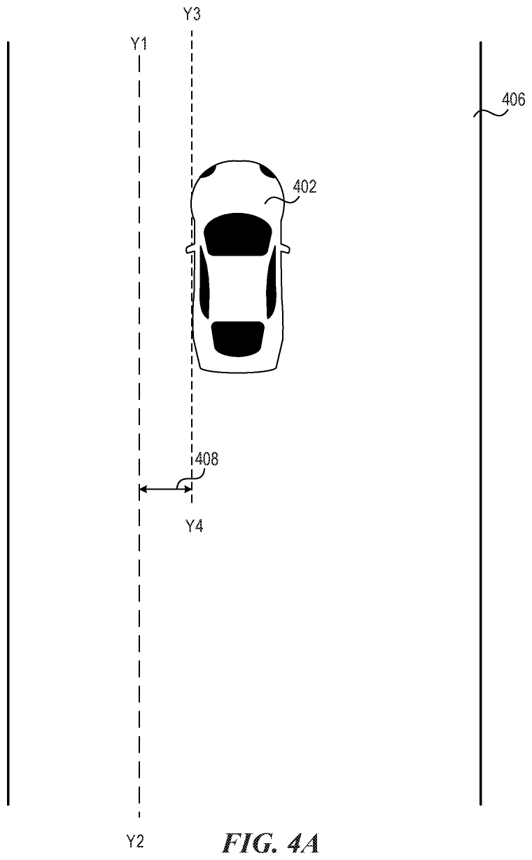

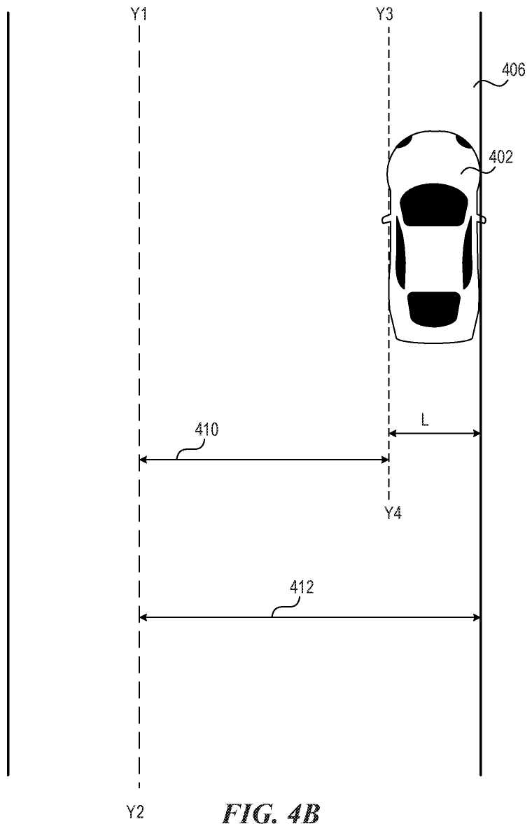

FIGS. 4A and 4B illustrate various examples of offset displacements applicable to tire placement of vehicles. For example, FIG. 4A demonstrates vehicle 402 traveling on roadway 406 along an original direction Y1Y2. Without applying an offset displacement, vehicle 402 would have traveled along the direction Y1Y2. By applying an offset displacement 408 with respect to its original path Y1Y2, the original path Y1Y2 of vehicle 402 gets modified to travel along new path Y3Y4, shown with respect to an axis passing through the left tires of vehicle 402.

FIG. 4B illustrates a scenario in which vehicle 402 applies an offset displacement (e.g., a maximum offset 410 with respect to its original path Y1Y2) to avoid hitting the side of the roadway 406. If the width of the car is L and the distance (with respect to original path Y1Y2) to the edge of roadway 406 is denoted as 412, then the maximum offset displacement 410 can be equated as distance 412-L. As a result, vehicle 402 modifies its path from Y1Y2 to Y3Y4 in FIG. 4B, shown with respect to an axis passing through the left tires of vehicle 402. In some embodiments, if the offset displacement (e.g., measured by the vehicles with respect to the middle of the roadway) applied by vehicle 1 is D1, the other vehicles on the roadway are informed of D1, either directly by the vehicle, or indirectly by a server. Upon receiving information about vehicle 1 applying an offset D1 the other vehicles can apply offsets D1+X1, D1+X2, D1+X3, where X1, X2, X3 can be random numbers generated by the vehicular computers of the other vehicles on the roadway with the constraint that the offset calculated as Di−+Xi does not exceed the width of the roadway. In some embodiments, X1, X2, X3 . . . can be random numbers generated using different random distributions.

Thus, FIGS. 4A and 4B demonstrate that a value of offset displacement can lie lying between a minimum value (e.g., zero) and a maximum value (e.g., dependent on the width of the roadway or distance to other obstacles on the roadway).

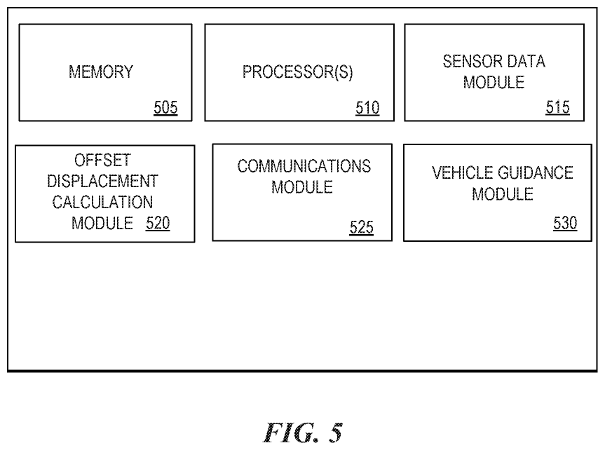

FIG. 5 illustrates an example architecture of a vehicular computer according to some embodiments of the disclosed technology. The vehicular computer (e.g., one or more data processors) is capable of executing algorithms, software routines, instructions, based on processing data provided by a variety of sources related to the control of the vehicle. The vehicular computer can be a factory-fitted system or an add-on unit retrofitted into a vehicle. Furthermore, the vehicular computer can be a general-purpose computer or a dedicated, special-purpose computer. No limitations are imposed on the location of the vehicular computer relative to the vehicle. According to the embodiments shown in FIG. 5, the disclosed system can include memory 505, one or more processors 510, sensor data module 515, offset displacement calculation module 520, communications module 525, and vehicle guidance module 530. Other embodiments of the present technology may include some, all, or none of these modules and components, along with other modules, applications, data, and/or components. Still yet, some embodiments may incorporate two or more of these modules and components into a single module and/or associate a portion of the functionality of one or more of these modules with a different module.

Memory 505 can store instructions for running one or more applications or modules on processor(s) 510. For example, memory 505 could be used in one or more embodiments to house all or some of the instructions needed to execute the functionality of sensor data module 515, offset displacement calculation module 520, communications module 525, and vehicle guidance module 530. Generally, memory 505 can include any device, mechanism, or populated data structure used for storing information. In accordance with some embodiments of the present disclosure, memory 505 can encompass, but is not limited to, any type of volatile memory, nonvolatile memory, and dynamic memory. For example, memory 505 can be random access memory, memory storage devices, optical memory devices, magnetic media, floppy disks, magnetic tapes, hard drives, SIMMs, SDRAM, DIMMs, RDRAM, DDR RAM, SODIMMS, EPROMs, EEPROMs, compact discs, DVDs, and/or the like. In accordance with some embodiments, memory 505 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information that can be used as memory 505.

Sensor data module 515 receives information from and transmits information to multiple sensors coupled to the vehicle. Examples of sensors can be video cameras, still cameras, LIDAR units, radar units, GPS units, speed sensors, acceleration sensors, environmental sensors such as temperature/weather sensors for sensing ambient weather, operational data associated with one or more vehicle parts such as a tire, radiation sensors for detecting chemicals in the air, or otherwise any suitable sensors coupled to the vehicle. Sensors can be attached anywhere in the vehicle, e.g., to the top, to the rear, on the sides, underneath, on or inside at least one tire of the vehicle, or any other suitable position inside or outside the vehicle. Also, sensors can be of different types and from different manufacturers or vendors. Data from sensors can be utilized to calculate relative distance data to one or more nearby objects/obstacles on the roadway. Examples of objects can be a pedestrian, other vehicles, a traffic light, a sidewalk, a shoulder of a road, a billboard, a speed post, a traffic sign, or otherwise any physical object that can be detected by sensors. In some embodiments, the vehicular computer can self-generate a map based on data communicated by sensor data module 515, showing locations of structural artifacts (e.g., ruts, potholes, etc.) and/or locations of objects (e.g., pedestrians, traffic lights, shoulder of roadway, etc.).

Offset displacement calculation module 520 is configured to receive information from sensor data module 515 and/or external sources to calculate an offset displacement for tire placement relative to the current position of the vehicle. The received information can be based on one or more factors such as the location information of the structural artifacts/deformities on the roadway, the instantaneous position of objects located on the portion of the roadway, operational data associated with the at least one tire, and the environmental data external to the vehicle. The operational data can be (or, related to) a speed of travel of at least one tire, an acceleration of the at least one tire, a direction of travel of the at least one tire, a vehicular weight on the at least one tire, and a frictional force of the roadway impacting the at least one tire. In some embodiments, the offset displacement has a value and a direction, e.g., relative to a current position of the vehicle or relative to a detected structural artifact on the roadway.

Communications module 525 is associated with sending/receiving information (e.g., collected by sensor data module 515) with a remote server or with one or more nearby vehicles traveling on the road. These communications can employ any suitable type of technology, such as Bluetooth, Wifi, WiMax, cellular, single hop communication, multi-hop communication, Dedicated Short Range Communications (DSRC), or a proprietary communication protocol. In some embodiments, communications module 525 sends information collected by sensor data module 515

Vehicle guidance module 530 is associated with the functionality of driving the vehicle on the roadway, including modifying the path of the vehicle to generate a new position of the vehicle, based on information from sensor data module 515, offset displacement calculation module 520, and communications module 525. In some embodiments, vehicle guidance module 530 can predict an expected outcome of impact between the vehicle and a structural artifact; calculate a probability of the expected outcome of impact between the vehicle and a structural artifact and also determine that the probability is greater than a threshold value. In some embodiments, vehicle guidance module 530 can optionally calculate a metric indicative of savings from the reduced wear and tear of the roadway, based on applying the offset displacement to the current position of the vehicle. Vehicle guidance module 530 can employ one or more machine learning algorithms such as artificial intelligence, neural networks, Tensor Flow, or any other suitable methodology to generate a new position of the vehicle.

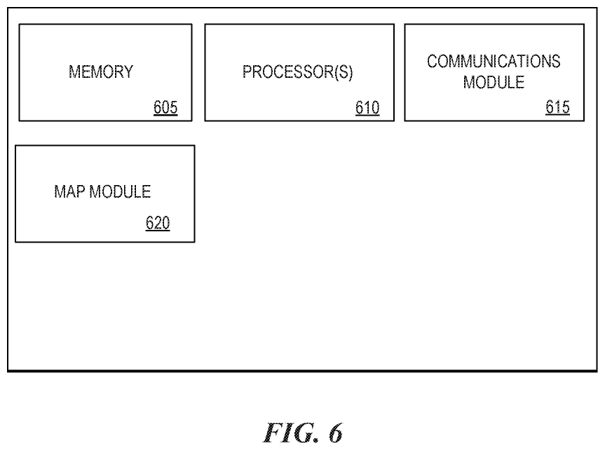

FIG. 6 illustrates an example architecture of a remote computer, according to some embodiments of the disclosed technology. Referring to FIG. 6, an example internal architecture of a remote server (or, servers) is shown, according to some embodiments of the disclosed technology. According to the embodiments shown in FIG. 6, the disclosed system can include memory 605, one or more processors 610, communications module 615, and map module 620. Memory 605 and processor 610 are similar to memory 505 and processor 510 discussed in connection with FIG. 5.

Communications module 615 exchanges information (e.g., about objects or structural artifacts on a roadway) with geocoding databases such as GOOGLE, vehicular computers of vehicles moving on roadways, or other servers. In some embodiments, communications module 615 can use an application programming interface (API) to exchange information with various remotes servers.

Map module 620 can be configured to create a map of objects/obstacles/roadway deformities based on information received from communications module 615. In some embodiments, information received from communications module 615 can include information about traffic congestions. The map can be communicated to vehicles on the road by communications module 615.

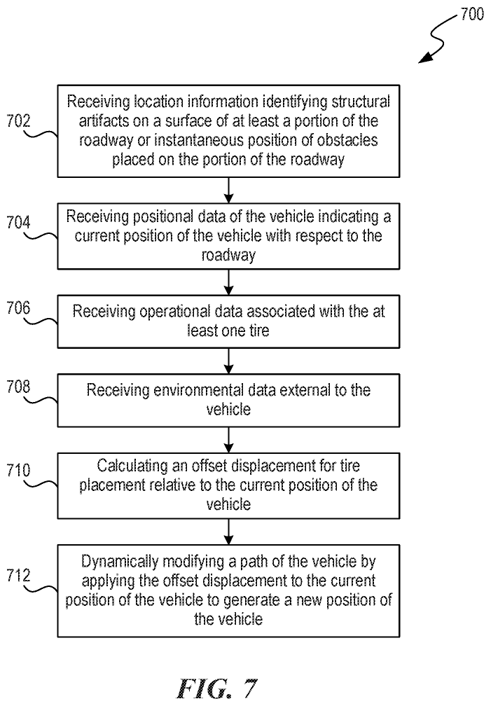

FIG. 7 illustrates steps of a flowchart associated with calculating an offset displacement applicable to tire placement, according to some embodiments of the disclosed technology. Starting at step 702, the vehicular computer receives (e.g., from one or more sensors coupled to the vehicle or a remote server) location information identifying structural artifacts (such as ruts, potholes, bumps, dips, etc.) on a surface of a portion of the roadway and/or instantaneous position of objects located on the portion of the roadway. At step 704, the vehicular computer receives (e.g., from one or more sensors coupled to the vehicle or a remote server) positional data of the vehicle indicating a current position of the vehicle with respect to the roadway. At step 706, operational data associated with at least one tire of the vehicle is received (e.g., from a sensor coupled to the vehicle) by the vehicular computer. The operational data can be measured along radial, tangential, and lateral directions with respect to a circumference of the at least one tire. Examples of operational data can include slip ratio, brake pressure or braking torque, engine torque, wheel torque, steering wheel angle, and the like. External environmental data is received (at step 708) from a temperature sensor coupled to the vehicle. Examples of sensors can be video cameras, still cameras, LIDAR units, radar units, GPS units, speed sensors, acceleration sensors, environmental sensors such as temperature/weather sensors for sensing ambient weather, operational data associated with one or more vehicle parts such as a tire, infrared, or thermal cameras, radiation sensors for detecting chemicals in the air, or otherwise any suitable sensors coupled to the vehicle. Sensors can be attached anywhere in the vehicle, e.g., to the top, to the rear, on the sides, underneath, on or inside at least one tire of the vehicle, or any other suitable position inside or outside the vehicle. Also, sensors can be of different types and from different manufacturers or vendors. In some embodiments, the disclosed vehicular computer can self-generate a map based on data communicated by showing locations of structural artifacts (e.g., ruts, potholes, etc.) and/or locations of objects (e.g., pedestrians, traffic lights, shoulder of roadway, etc.). In some embodiments, the positional data of the vehicle indicating a current position of the vehicle is obtained based on a comparison of (i) the operational data associated with the at least one tire with (ii) factory-determined parameters corresponding to the at least one tire specified under conditions of the external environmental data (collected by sensors coupled to the vehicle). Factory-determined parameters may be locally stored data provided by a manufacturer, a mechanic, a user, an owner, and/or other entity having specifications and/or measurements for the physical dimensions of the vehicle and corresponding to a given set of environmental data.

At step 710, the vehicular computer calculates an offset displacement for the vehicle's tire placement, based on any combination of the following data: the location information of the structural artifacts, the instantaneous position of objects located on the portion of the roadway, the operational data associated with the at least one tire, or the environmental data. The offset displacement can correspond to a safe driving action that can be applicable over a short future time horizon (of the order of fractions of seconds) or longer (2-5 seconds to tens of seconds, minutes, or many minutes).

In some embodiments, the offset displacement lies in an interval having a minimum value of offset displacement and a maximum value of offset displacement. At step 712, the vehicular computer modifies the path of the vehicle based on the calculated offset displacement that results in preventing, or otherwise reducing roadway degradation. Applying different offset displacements by different vehicles causes the vehicles to be staggered with respect to one another, i.e., the vehicles do not travel along a common straight line, thereby allowing greater usage of the roadway. As a result, the wear and tear of the roadway (from a vehicle travelling on the roadway) gets spread out over a wider portion of the roadway. As an illustrative example, if the offset displacement applied by a vehicle corresponds to its tire width, this can result in increased usage of the roadway and significantly reducing repair and replacement costs, in comparison to conventional driving scenarios when no offset displacements are applied by vehicles traveling on a roadway.

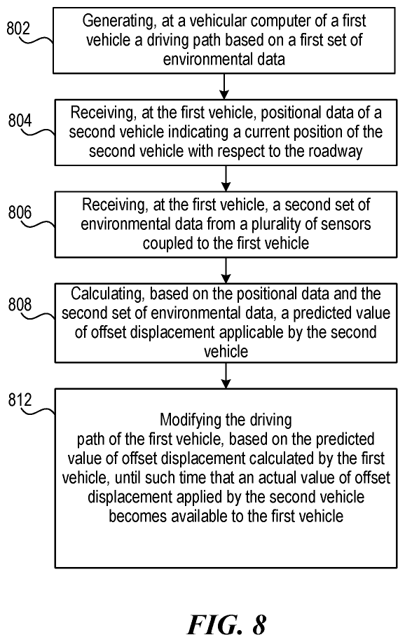

FIG. 8 illustrates steps of a flowchart associated with a first vehicle modifying its driving path based on offset displacement applied by a second vehicle on the roadway, according to some embodiments of the disclosed technology. For example, the flowchart in FIG. 8 illustrates a scenario when offset displacement applied by a second vehicle causes the first vehicle to modify its driving path, when both the first and the second vehicles are moving on the roadway. Such a scenario can arise when the second vehicle is unable to communicate its offset displacement to the first vehicle, due to temporary communication failures when the vehicles are out-of-range or other reasons. In such a scenario, the first vehicle calculates a predicted value of offset displacement that may be applicable to the second vehicle, and decides to modify its driving path accordingly. The two vehicles can be in the same lane or, in different lanes. Further, the two vehicles may be headed along the same direction or they may be headed in different directions. At step 802, a vehicular computer in a first vehicle generates a driving path of the first vehicle based on a first set of environmental data. For example, the driving path may be based on weather, a current location of the first vehicle, the destination of the first vehicle, real-time traffic data in a geographical area around the current location of the first vehicle, etc. Based on the generated driving path, the first vehicle travels on a roadway shared by a second vehicle. At some location along the roadway, the second vehicle sends (step 804) its positional data (in real time or near real time) to the first vehicle. The positional data can be based on DSRC or other suitable wireless communication protocols. The first vehicle can also receive (step 806) a second set of environmental parameters from a plurality of sensors coupled to the first vehicle. Examples of sensors can be video cameras, still cameras, LIDAR units, radar units, GPS units, speed sensors, acceleration sensors, environmental sensors such as temperature/weather sensors for sensing ambient weather, operational data associated with one or more vehicle parts such as a tire, infrared, or thermal cameras, radiation sensors for detecting chemicals in the air, or otherwise any suitable sensors coupled to the vehicle. Sensors can be attached anywhere in the vehicle, e.g., to the top, to the rear, on the sides, underneath, on or inside at least one tire of the vehicle, or any other suitable position inside or outside the vehicle. Also, sensors can be of different types and from different manufacturers or vendors. At step 808, the first vehicle calculates a predicted value of offset displacement that can be applicable by the second vehicle to spread wear and tear over a larger portion of the roadway. The predicted value of the offset displacement applicable by the second vehicle can be based on the positional data from the first vehicle and/or the second set of environmental data. One scenario where the first vehicle calculates the predicted value of the offset displacement applicable by the second vehicle is when a temporary communication failure happens between the first vehicle and the second vehicle. As a result, the first vehicle may be unaware of the actual value of the offset displacement of the second vehicle, and hence estimates the actual value using the predicted value. Based on the predicted value of offset displacement calculated by the first vehicle, the vehicular computer at the first vehicle modifies (step 812) the driving path of the first vehicle, until such time that the actual value of offset displacement of the second vehicle becomes available to the first vehicle, e.g., the communication link comes back up.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

I/We claim:

1. A computer-implemented method associated with a vehicle on a roadway for reducing degradation of the roadway comprising:
receiving location information identifying structural artifacts on a surface of at least a portion of the roadway and instantaneous position of objects located on the portion of the roadway;
receiving positional data of the vehicle indicating a current position of the vehicle with respect to the roadway;
receiving, from at least one tire sensor connected to at least one tire of the vehicle, operational data associated with the at least one tire;
receiving, from at least one temperature sensor connected to the vehicle, environmental data external to the vehicle;
calculating an offset displacement for tire placement relative to the current position of the vehicle based on at least one of: the location information of the structural artifacts, the instantaneous position of objects located on the portion of the roadway, the operational data associated with the at least one tire, or the environmental data external to the vehicle; and
dynamically modifying a path of the vehicle by applying the offset displacement to the current position of the vehicle to generate a new position of the vehicle, wherein applying the offset displacement for tire placement results in reduced degradation of the roadway.

2. The method of claim 1, wherein the structural artifacts include at least one of: ruts, potholes, bumps, and dips.

3. The method of claim 1, wherein the objects include a pole, a traffic light, a boundary wall, a shoulder of the roadway, one or more other vehicles in proximity of the vehicle, a pedestrian, an animal, a tower, a tree, a building, a sidewalk, a partition on the roadway, a road barrier, a fence, and a construction zone.

4. The method of claim 1, wherein the location information of the structural artifacts is received from one or more position sensors connected to the vehicle, a remote server communicably coupled to the vehicle, or another vehicle communicably coupled to the vehicle and traveling on the portion of the roadway.

5. The method of claim 1, wherein the positional data of the vehicle is received from: a LIDAR unit associated with the vehicle, a radar unit associated with the vehicle, a camera unit associated with the vehicle, or a GPS unit associated with the vehicle.

6. The method of claim 1, wherein the operational data associated with the at least one tire includes: a speed of travel of the at least one tire, an acceleration of the at least one tire, a direction of travel of the at least one tire, a vehicular weight on the at least one tire, and a frictional force of the roadway impacting the at least one tire.

7. The method of claim 6, wherein the operational data associated with the at least one tire is measured along radial, tangential, and lateral directions with respect to a circumference of the at least one tire.

8. The method of claim 1, wherein the environmental data external to the vehicle includes at least one of: an ambient temperature, an ambient pressure, an ambient humidity, a condition of the roadway, a wind speed, an amount of rainfall, an amount of snow, and an amount of ambient light.

9. The method of claim 1, further comprising:
calculating a metric indicative of savings from the reduced wear and tear of the roadway, based on applying the offset displacement to the current position of the vehicle.

10. The method of claim 1, wherein the positional data of the vehicle indicating a current position of the vehicle is obtained based on a comparison of (i) the operational data associated with the at least one tire with (ii) factory-determined parameters corresponding to the at least one tire specified under conditions of the environmental data external to the vehicle.

11. The method of claim 1, wherein the offset displacement lies in an interval having a minimum value of offset displacement and a maximum value of offset displacement.

12. A non-transitory machine-readable storage medium having stored thereon instructions which, when executed by a processor included in a vehicle, cause the processor to:
receive location information identifying structural artifacts on a surface of at least a portion of the roadway and instantaneous position of objects located on the portion of the roadway;
receive positional data of the vehicle indicating a current position of the vehicle with respect to the roadway;
receive, from at least one tire sensor connected to at least one tire of the vehicle, operational data associated with the at least one tire;
receive, from at least one temperature sensor connected to the vehicle, environmental data external to the vehicle;
calculate an offset displacement for tire placement relative to the current position of the vehicle based on at least one of: the location information of the structural artifacts, the instantaneous position of objects located on the portion of the roadway, the operational data associated with the at least one tire, or the environmental data external to the vehicle; and
dynamically modify a path of the vehicle by applying the offset displacement to the current position of the vehicle to generate a new position of the vehicle, wherein applying the offset displacement for tire placement results in reduced degradation of the roadway.

13. The non-transitory machine-readable storage medium of claim 12, wherein the operational data associated with the at least one tire includes: a speed of travel of the at least one tire, an acceleration of the at least one tire, a direction of travel of the at least one tire, a vehicular weight on the at least one tire, and a frictional force of the roadway impacting the at least one tire

14. The non-transitory machine-readable storage medium of claim 12, wherein the operational data associated with the at least one tire is measured along radial, tangential, and lateral directions with respect to a circumference of the at least one tire.

15. The non-transitory machine-readable storage medium of claim 12, wherein the environmental data external to the vehicle includes at least one of: an ambient temperature, an ambient pressure, an ambient humidity, a condition of the roadway, a wind speed, an amount of rainfall, an amount of snow, and an amount of ambient light.

16. A vehicular computer comprising:
a memory;
a processor coupled to the memory, wherein the processor is configured to:
receive location information identifying structural artifacts on a surface of at least a portion of the roadway and instantaneous position of objects located on the portion of the roadway;
receive positional data of the vehicle indicating a current position of the vehicle with respect to the roadway;
receive, from at least one tire sensor connected to at least one tire of the vehicle, operational data associated with the at least one tire;
receive, from at least one temperature sensor connected to the vehicle, environmental data external to the vehicle;
calculate an offset displacement for tire placement relative to the current position of the vehicle based on at least one of: the location information of the structural artifacts, the instantaneous position of objects located on the portion of the roadway, the operational data associated with the at least one tire, or the environmental data external to the vehicle; and
dynamically modify a path of the vehicle by applying the offset displacement to the current position of the vehicle to generate a new position of the vehicle, wherein applying the offset displacement for tire placement results in reduced degradation of the roadway.

17. The vehicular computer of claim 16, wherein the operational data associated with the at least one tire includes: a speed of travel of the at least one tire, an acceleration of the at least one tire, a direction of travel of the at least one tire, a vehicular weight on the at least one tire, and a frictional force of the roadway impacting the at least one tire.

18. The vehicular computer of claim 16, wherein the operational data associated with the at least one tire is measured along radial, tangential, and lateral directions with respect to a circumference of the at least one tire.

19. The vehicular computer of claim 1, wherein the processor is further configured to:
calculate a metric indicative of savings from the reduced wear and tear of the roadway, based on applying the offset displacement to the current position of the vehicle.

20. The vehicular computer of claim 16, wherein the positional data of the vehicle indicating a current position of the vehicle is obtained based on a comparison of (I) the operational data associated with the at least one tire with (ii) factory-determined parameters corresponding to the at least one tire specified under conditions of the environmental data external to the vehicle.
